(19) United States
(12) Patent Application Publication
(10) Pub. No.: US 2025/0218042 A1
(43) Pub. Date: Jul. 3, 2025

(54) GROUND SURFACE DETECTION METHOD AND APPARATUS, AND TERMINAL DEVICE

(71) Applicant: Beijing Zitiao Network Technology Co., Ltd., Beijing (CN)

(72) Inventor: Kai HUANG, Beijing (CN)

(21) Appl. No.: 18/991,294

(22) Filed: Dec. 20, 2024

(30) Foreign Application Priority Data
Dec. 29, 2023 (CN) 202311865937.0

(51) Int. Cl. G06T 7/80

(52) U.S. Cl. CPC G06T 7/80; G06T 2207/10028

(57) ABSTRACT

The present disclosure provides a ground surface detection method and apparatus, and a terminal device. The method includes: acquiring an image acquisition position in a target scene; determining a target point cloud from a point cloud related to the target scene according to the image acquisition position, wherein the target point cloud is a point cloud in a preset range below the image acquisition position in the target scene; determining a height distribution of the target point cloud in the target scene; and determining a position of a ground surface in the target scene according to the image acquisition position and the height distribution of the target point cloud.

### CROSS-REFERENCE TO RELATED APPLICATION(S)

This application claims the priority to Chinese patent application No. 202311865937.0 filed with the CNIPA on Dec. 29, 2023 and entitled “GROUND SURFACE DETECTION METHOD AND APPARATUS, AND TERMINAL DEVICE”, which is incorporated herein in its entirety by reference.

### TECHNICAL FIELD

Embodiments of the present disclosure relate to the technical field of three-dimensional modeling, in particular to a ground surface detection method and apparatus, and a terminal device.

### BACKGROUND

Ground surface detection of three-dimensional scene is particularly important for three-dimensional scene restoration. A terminal device can determine the position of the ground surface of a three-dimensional scene based on point clouds of the three-dimensional scene.

At present, the terminal device can determine a plane in a three-dimensional scene based on at least three points, and determine the number of interior points (points contained in the plane) of the plane. By repeating the above steps, the terminal device can determine multiple planes in the three-dimensional scene and determine the plane with the largest number of interior points as the ground surface of the three-dimensional scene. However, when the environment of the three-dimensional scene is complex, the plane with the largest number of interior points may not be the ground surface of the three-dimensional scene, which leads to low accuracy of ground surface detection of the three-dimensional scene.

### SUMMARY

The present disclosure provides a ground surface detection method and apparatus, and a terminal device, which are intended to solve the technical problem of low accuracy of ground surface detection of a three-dimensional scene in the prior art.

In a first aspect, the present disclosure provides a ground surface detection method, including:
acquiring an image acquisition position in a target scene;
determining a target point cloud from a point cloud related to the target scene according to the image acquisition position, where the target point cloud is a point cloud located within a preset range below the image acquisition position in the target scene;
determining a height distribution of the target point cloud in the target scene; and
determining a position of a ground surface in the target scene according to the image acquisition position and the height distribution of the target point cloud.

In a second aspect, the present disclosure provides a ground surface detection apparatus, including an acquisition module, a first determination module, a second determination module and a third determination module, where:
the acquisition module is configured to acquire an image acquisition position in a target scene;
the first determination module is configured to determine a target point cloud from a point cloud related to the target scene according to the image acquisition position, where the target point cloud is a point cloud located within a preset range below the image acquisition position in the target scene;
the second determination module is configured to determine a height distribution of the target point cloud in the target scene; and
the third determination module is configured to determine a position of a ground surface in the target scene according to the image acquisition position and the height distribution of the target point cloud.

In a third aspect, an embodiment of the present disclosure provides a terminal device including a processor and a memory;
the memory is configured to store computer-executable instructions; and
the processor is configured to execute the computer-executable instructions stored in the memory, so as to execute the ground surface detection method as described in the first aspect above and various possible aspects of the first aspect.

In a fourth aspect, an embodiment of the present disclosure provides a computer-readable storage medium, in which computer-executable instructions are stored, and the computer-executable instructions, when executed by a processor, are configured to realize the ground surface detection method as described in the first aspect above and various possible aspects of the first aspect.

### BRIEF DESCRIPTION OF DRAWINGS

In order to explain the embodiments of the present disclosure or the technical solution in the prior art more clearly, the drawings necessary for the description of the embodiments or the prior art will be briefly introduced below. Obviously, the drawings in the following description are some embodiments of the present disclosure, and other drawings can be obtained according to these drawings without creative labor.

FIG. 1 is a schematic diagram of an application scenario provided by an embodiment of the present disclosure;

FIG. 2 is a flowchart of a ground surface detection method provided by some embodiments of the present disclosure;

FIG. 3 is a schematic diagram of determining a target point cloud provided by an embodiment of the present disclosure;

FIG. 4 is a schematic diagram of a histogram provided by an embodiment of the present disclosure;

FIG. 5 is a schematic diagram of a method for determining a position of a ground surface provided by an embodiment of the present disclosure;

FIG. 6 is a schematic diagram of another method for determining a position of a ground surface provided by an embodiment of the present disclosure;

FIG. 7 is a schematic diagram of a weight function provided by an embodiment of the present disclosure;

FIG. 8 is a schematic diagram of a saturation function provided by an embodiment of the present disclosure;

FIG. 9 is a schematic diagram of a saturation process provided by an embodiment of the present disclosure;

FIG. 10 is a schematic diagram of determining a weighted height distribution function provided by an embodiment of the present disclosure;

FIG. 11 is a schematic diagram illustrating a process flow of a ground surface detection method provided by an embodiment of the present disclosure;

FIG. 12 is a schematic structural diagram of a ground surface detection apparatus provided by an embodiment of the present disclosure; and

FIG. 13 is a schematic structural diagram of a terminal device provided by an embodiment of the present disclosure.

### DETAILED DESCRIPTION

Reference now will be made in details to exemplary embodiments, examples of which are illustrated in the accompanying drawings. When the following description refers to the drawings, the same numbers in different drawings indicate the same or similar elements, unless otherwise indicated. The implementations described in the following exemplary embodiments do not represent all embodiments consistent with the present disclosure. Rather, they are merely examples of devices and methods consistent with some aspects of the present disclosure as detailed in the appended claims.

In order to facilitate understanding, the concepts related to the embodiments of the present disclosure are described below.

Terminal device: it is a kind of equipment with wireless transceiver function. Terminal device can be deployed on land, including indoor or outdoor, handheld, wearable or vehicle-mounted terminal devices. The terminal device can be a mobile phone, a tablet computer (Pad), a computer with wireless transceiver function, a virtual reality (VR) terminal device, an augmented reality (AR) terminal device, a wireless terminal device in industrial control, a vehicle-mounted terminal device, a wireless terminal device in self-driving application, a wireless terminal device in remote medical application, a wireless terminal device in smart grid, a wireless terminal device in transportation safety, a wireless terminal device in smart city, a wireless terminal device in smart home, and a wearable terminal device, etc. The terminal device involved in the embodiments of the present disclosure can also be referred to as terminal, user equipment (UE), access terminal device, vehicle-mounted terminal, industrial control terminal, UE unit, UE station, mobile station, mobile stage, remote station, remote mobile device, UE terminal device, wireless communication equipment, UE agent or UE device, etc. Terminal device can also be fixed or movable.

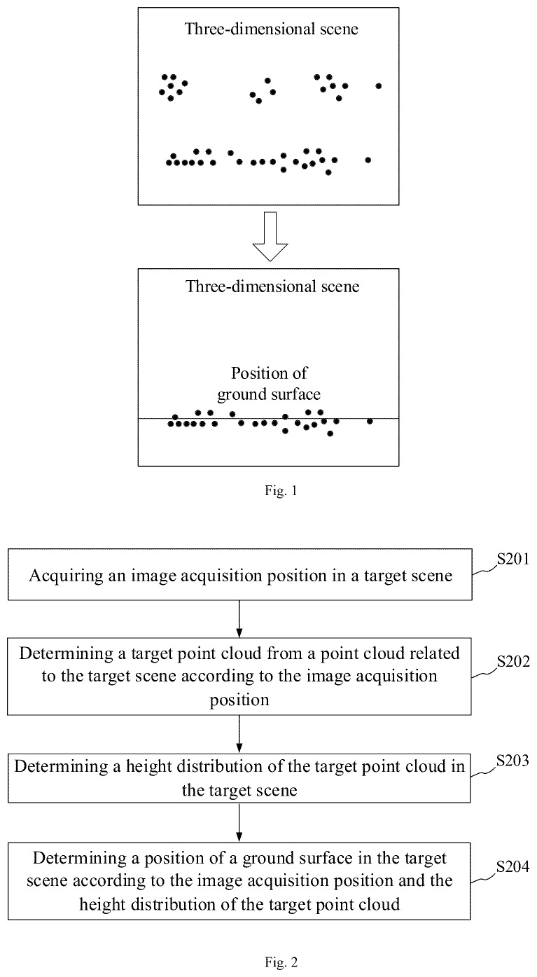

Hereinafter, with reference to FIG. 1, an application scenario of an embodiment of the present disclosure will be described.

FIG. 1 is a schematic diagram of an application scenario provided by an embodiment of the present disclosure. Referring to FIG. 1, the application scenario includes a three-dimensional scene. The three-dimensional scene can be a scene to be built, and when the terminal device generates a three-dimensional scene, objects in the three-dimensional scene need to be determined based on point cloud information associated with the three-dimensional scene. The three-dimensional scene can include multiple point clouds, and the terminal device can determine the position of the ground surface in the three-dimensional scene according to the density of the multiple point clouds in the three-dimensional scene, so that the terminal device can accurately construct the three-dimensional scene, and the accuracy of the three-dimensional scene can be improved.

It should be noted that FIG. 1 is only an example of the application scenario of the embodiment of the present disclosure, and is not a limitation of the application scenario of the embodiment of the present disclosure.

In related technologies, the ground surface detection of a three-dimensional scene is particularly important for the construction of the three-dimensional scene, and the terminal device can determine the position of the ground surface of the three-dimensional scene based on the points in the three-dimensional scene. For example, a three-dimensional scene can include a plurality of point clouds, and the terminal device can determine the ground surface in the three-dimensional scene according to the density of the point clouds on a plane. At present, the terminal device can determine a plane in the three-dimensional scene according to at least three points, and determine the number of interior points of the plane. The terminal device can repeat the above steps to obtain multiple planes in the three-dimensional scene, and determine the plane with the largest number of interior points as the ground surface of the three-dimensional scene. For example, the terminal device determines a plane A according to one set of point clouds and determines a plane B according to another set of point clouds. If the number of interior points in plane A is greater than that in plane B, the terminal device can determine the plane A as the ground surface of the three-dimensional scene. However, the determination of the ground surface according to the number of interior points in the plane is poor in accuracy. For example, when the three-dimensional scene is complex, a plane parallel to the gravity direction may have the largest number of interior points, but this plane is not the ground surface of the three-dimensional scene, which leads to lower accuracy of ground surface detection in the three-dimensional scene.

In order to solve the technical problems in related technologies, an embodiment of the present disclosure provides a ground surface detection method. Terminal device can acquire an image acquisition position in a target scene, and determine a target point cloud from a point cloud related to the target scene according to the image acquisition position, where the target point cloud is a point cloud located within a preset range below the image acquisition position in the target scene; and the terminal device can determine a height distribution of the target point cloud in the target scene, and generate a height distribution function according to the image acquisition position, the height distribution and a preset class interval, where an independent variable of the height distribution function is a height difference between the target point cloud and the image acquisition position, and a dependent variable of the height distribution function is a number of points of the target point cloud; and the terminal device can determine the position of the ground surface in the target scene according to the height distribution function. In this way, since the target point cloud is located within the preset range below the image acquisition position, the target point cloud includes a point cloud of the ground surface where a target scene is built, and the terminal device can quickly and accurately determine a plane with lower height, more interior points and perpendicular to the gravity direction according to the height distribution function, thereby improving the accuracy and efficiency of ground surface detection in the target scene.

The technical solution of the present disclosure and how the technical solution of the present disclosure can solve the above technical problems will be described in detail with exemplary embodiments. The following exemplary embodiments can be combined with each other, and the same or similar concepts or processes may not be repeated in some embodiments. Embodiments of the present disclosure will be described below with reference to the accompanying drawings.

FIG. 2 is a flowchart of a ground surface detection method provided by some embodiments of the present disclosure. Referring to FIG. 2, the method may include:

S201: acquiring an image acquisition position in a target scene.

The execution subject of the embodiment of the present disclosure may be a terminal device or a ground surface detection apparatus arranged in the terminal device. The ground surface detection apparatus can be realized in the form of software, or a combination of software and hardware, which is not limited by the embodiment of the present disclosure.

Optionally, the target scene can be a scene to be generated. For example, the target scene can be any environment-related scene, and the terminal device can restore the environment-related scene according to the environment information in the environment, so as to obtain the environment-related target scene.

Optionally, the target scene can be a three-dimensional scene. For example, the terminal device can obtain information of a plurality of point clouds associated with the environment, and can determine the objects included in the three-dimensional scene, the positions of the objects in the three-dimensional scene, the postures of the objects in the three-dimensional scene and the position of the ground surface in the three-dimensional scene according to the information of the plurality of point clouds, and construct the three-dimensional scene according to the above information.

It should be noted that the target scene may be a real scene associated with mixed reality technology, and this is not limited by the embodiment of the present disclosure.

It should be noted that the terminal device can determine the target scene based on any feasible implementation, which is not limited by the embodiment of the present disclosure.

For example, the image acquisition position may be the position where the image of the target scene is acquired. For example, in the field of three-dimensional reconstruction, the terminal device can acquire multiple images in the current scene, and then reconstruct the three-dimensional scene according to the multiple images, so the image acquisition position can be the position of the terminal device that acquires the images. For example, if the user wears an input device and acquires images of the environment related to the target scene according to the input device, the image acquisition position can be related to the position of the user's head; and if the user holds an input device with a hand and acquires images of the environment related to the target scene according to the input device, the image acquisition position can be related to the position of the user's hand.

It should be noted that the terminal device can determine the image acquisition position in the target scene according to any feasible implementation, which is not limited by the embodiment of the present disclosure.

S202: determining a target point cloud from a point cloud related to the target scene according to the image acquisition position.

For example, the target point cloud is located within a preset range below the image acquisition position in the target scene. For example, the point cloud related to the target scene may include a point A, a point B, a point C and a point D. If the points A, B and C are within a preset range below the image acquisition position, the terminal device can determine the points A, B and C as the points in the target point cloud.

It should be noted that the terminal device can obtain the point cloud related to the target scene according to any feasible implementation (for example, the point clouds of multiple environments can be stored in the database; if the target scene is the scene of environment 1, the terminal device can obtain the point cloud of environment 1 in the database; if the target scene is the scene of environment 2, the terminal device can obtain the point cloud of environment 2 in the database; the terminal device can also calculate the point cloud related to the target scene according to the data acquired in the current and/or previous period of time), which is not limited by the embodiment of the present disclosure.

Optionally, the terminal device can determine the target point cloud from a point cloud related to the target scene according to the following feasible implementation: determining a to-be-selected point cloud range from the point cloud related to the target scene according to the image acquisition position, and determining, from the to-be-selected point cloud range, a to-be-selected point cloud whose height is smaller than a height of the image acquisition position and whose height difference relative to the image acquisition position is within a preset height range as the target point cloud.

For example, the to-be-selected point cloud range can include to-be-selected point clouds whose distance from the image acquisition position is less than or equal to a second threshold. For example, the to-be-selected point cloud can be a point cloud in the target scene whose distance from the image acquisition position is less than or equal to 6 meters. For example, the to-be-selected point cloud can be a point cloud in the target scene with the image acquisition position as a spherical center and a radius of 6 meters. For example, the terminal device can determine the coordinates of the point cloud related to the target scene, and calculate the distance between the point cloud in the target scene and the image acquisition position according to the coordinates of the point cloud and the image acquisition position, so as to determine the to-be-selected point cloud from the point cloud related to the target scene.

For example, the preset height range can be any range, for example, the preset height range can be 0.05-2 meters, and the preset height range can also be 0.1-2 meters, which is not limited by the embodiment of the present disclosure.

Optionally, the terminal device can take the height of the image acquisition position as a reference height, and calculate the distance between the to-be-selected point cloud and the image acquisition position in the gravity direction to obtain the height difference between the to-be-selected point cloud and the image acquisition position. For example, for any to-be-selected point cloud, the terminal device can project the image acquisition position and the to-be-selected point cloud in the gravity direction, and calculate the height of the to-be-selected point cloud and the height of the image acquisition position in the gravity direction, so as to obtain the height difference between the to-be-selected point cloud and the image acquisition position.

For example, the to-be-selected point cloud range includes a point A, a point B and a point C, and the preset height range can be 0.05-2 meters. If the height difference between the point A and the image acquisition position is 1.5 meters, the height difference between the point B and the image acquisition position is 3 meters, and the height difference between the point C and the image acquisition position is 2 meters, the terminal device can determine that the target point cloud includes the point A and the point C.

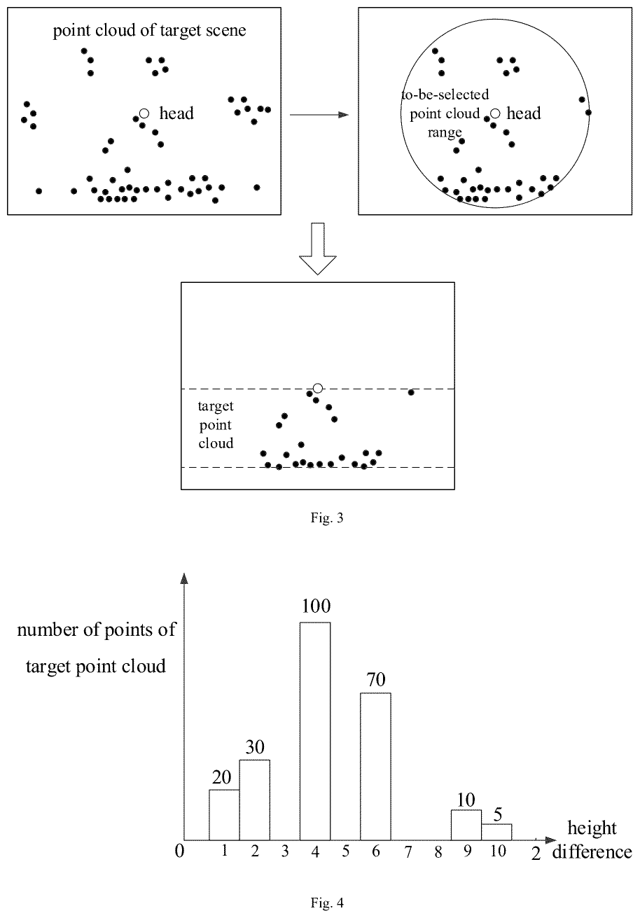

Hereinafter, with reference to FIG. 3, the process of determining the target point cloud by the terminal device will be described.

FIG. 3 is a schematic diagram of determining a target point cloud provided by an embodiment of the present disclosure. In the embodiment shown in FIG. 3, the image acquisition position is the position of the user's head, and a point cloud related to the target scene is included. As shown in FIG. 3, the white circle in the target scene is the position of the user's head (the position of the user's head can be related to the calculated position coordinates of the user's headset). A terminal device (not shown in FIG. 3) may determine the point clouds whose distance from the user's head is less than a second threshold as the to-be-selected point clouds. After the terminal device determines the to-be-selected point clouds, it can further determine the to-be-selected point cloud that is below the user's head and has a height difference within a preset height range as the target point cloud, so that the target point cloud can include the point cloud associated with the ground surface of the target scene, which improves the accuracy of ground surface detection. Furthermore, the terminal device can screen the point clouds of the target scene, thereby reducing the complexity of ground surface detection and improving the efficiency of ground surface detection.

S203: determining a height distribution of the target point cloud in the target scene.

The height distribution of the target point cloud can be the height distribution of the target point cloud in the gravity direction of the target scene. For example, after the terminal device determines the target point cloud in the target scene, it can project the positions of the target point cloud in the gravity direction of the target scene, and then the height distribution of the target point cloud in the gravity direction can be obtained.

Optionally, since there are a large number of points in the target point cloud, after the terminal device projects the target point cloud in the gravity direction of the target scene, a one-dimensional sequence of the target point cloud in the gravity direction can be obtained according to the height differences between the points in the target point cloud and the image acquisition position, and the terminal device can determine the height distribution of the target point cloud according to the one-dimensional sequence. For example, the target point cloud of the target scene includes a point 1, a point 2 and a point 3 (by way of example only, and there is no limitation on the number of the points in the target point cloud), the height difference between the point 1 and the image acquisition position is 0.5 meter, the height difference between the point 2 and the image acquisition position is 1 meter, and the height difference between the point 3 and the image acquisition position is 1.2 meters, so the one-dimensional sequence in the gravity direction can be: 0.5, 1, 1.2.

It should be noted that the terminal device can determine the height distribution of the target point cloud in the target scene according to any feasible implementation, and this is not limited by the embodiment of the present disclosure.

S204, determining a position of a ground surface in the target scene according to the image acquisition position and the height distribution of the target point cloud.

For example, the terminal device can determine the position of the ground surface in the target scene according to the following feasible implementation methods: generating a height distribution function according to the image acquisition position, the height distribution and a preset class interval; and determining the position of the ground surface in the target scene according to the height distribution function.

For example, an independent variable of the height distribution function is the height difference between the target point cloud and the image acquisition position, and a dependent variable of the height distribution function is the number of points of the target point cloud. For example, the terminal device can determine the height distribution function related to the target point cloud according to the image acquisition position, the height distribution of the target point cloud and a preset class interval. The terminal device can determine the number of the points of the target point cloud in each height difference range by taking the height of the image acquisition position as a reference height (the maximum or minimum value of the independent variable) and taking the preset class interval as a unit height difference, and then can generate the height distribution function.

Optionally, the height distribution function can be a histogram. For example, the preset class interval can be 0.5 centimeter; then the terminal device establishes a histogram with 400 bins by taking the height of the image acquisition position as a reference height, and taking a granularity of 0.5 centimeter (the height difference is 0.5 centimeter) within a range of 2 meters below the image acquisition position; the frequency of each bin can be the number of the points of the target point cloud within the height difference range. For example, the histogram generated by the terminal device includes 400 class intervals; if the number of the points in the target point cloud within the height difference range of a class interval 1 is 20, the frequency of the class interval 1 is 20; and if the number of the points in the target point cloud within the height difference range of a class interval 2 is 100, the frequency of the class interval 2 is 100.

Hereinafter, with reference to FIG. 4, the histogram corresponding to the height distribution function will be described.

FIG. 4 is a schematic diagram of a histogram provided by an embodiment of the present disclosure. Referring to FIG. 4, a histogram corresponding to a height distribution function is included. As shown in FIG. 4, the vertical axis of the histogram is the number of the points of the target point cloud, and the horizontal axis of the histogram is the height difference between the target point cloud and the image acquisition position, where the horizontal axis is ranged from 0 meter to 2 meters. For example, the histogram can include 10 class intervals, with the frequency of a class interval 1 being 20, the frequency of a class interval 2 being 30, the frequency of a class interval 4 being 100, the frequency of a class interval 6 being 70, the frequency of a class interval 9 being 10, the frequency of a class interval 10 being 5 and the frequency of other class intervals being 0.

Referring to FIG. 4, the terminal device can determine that the number of the points of the target point cloud within the height difference range associated with the class interval 1 is 20, the number of the points of the target point cloud within the height difference range associated with the class interval 2 is 30, the number of the points of the target point cloud within the height difference range associated with the class interval 4 is 100, the number of the points of the target point cloud within the height difference range associated with the class interval 6 is 70, the number of the points of the target point cloud within the height difference range associated with the class interval 9 is 10, and the number of the points of the target point cloud within the height difference range associated with the class interval 10 is 5, according to the histogram.

In this way, the terminal device can accurately determine the number of the interior points of multiple planes perpendicular to the gravity direction respectively, and then accurately determine the position of the ground surface in the target scene, which improves the accuracy of ground surface detection of the target scene.

Optionally, after the terminal device generates the height distribution function associated with the target point cloud, the position of the ground surface in the target scene can be determined according to the height distribution function. For example, the terminal device can determine the position corresponding to the highest peak in the height distribution function as the position of the ground surface. For example, in the embodiment shown in FIG. 4, the terminal device can determine the position corresponding to the class interval 4 as the position of the ground surface of the target scene.

The embodiment of the present disclosure provides a ground surface detection method. The terminal device can acquire an image acquisition position in a target scene, determine a to-be-selected point cloud range from a point cloud related to the target scene according to the image acquisition position, and determine, from the to-be-selected point cloud range, a to-be-selected point cloud whose height is smaller than a height of the image acquisition position and whose height difference relative to the image acquisition position is within a preset height range as the target point cloud. The terminal device can determine a height distribution of the target point cloud in the target scene, and generate a height distribution function according to the image acquisition position, the height distribution and a preset class interval, and then determine the position of the ground surface in the target scene according to the height distribution function. In this way, since the target point cloud is located within a preset range below the image acquisition position, the target point cloud includes the point cloud of the ground surface where the target scene is built; furthermore, the terminal device can obtain the position of a plane (ground surface) which has the most internal points and is perpendicular to the gravity direction according to the position of the peak of the height distribution function, thereby improving the accuracy of ground surface detection of the target scene.

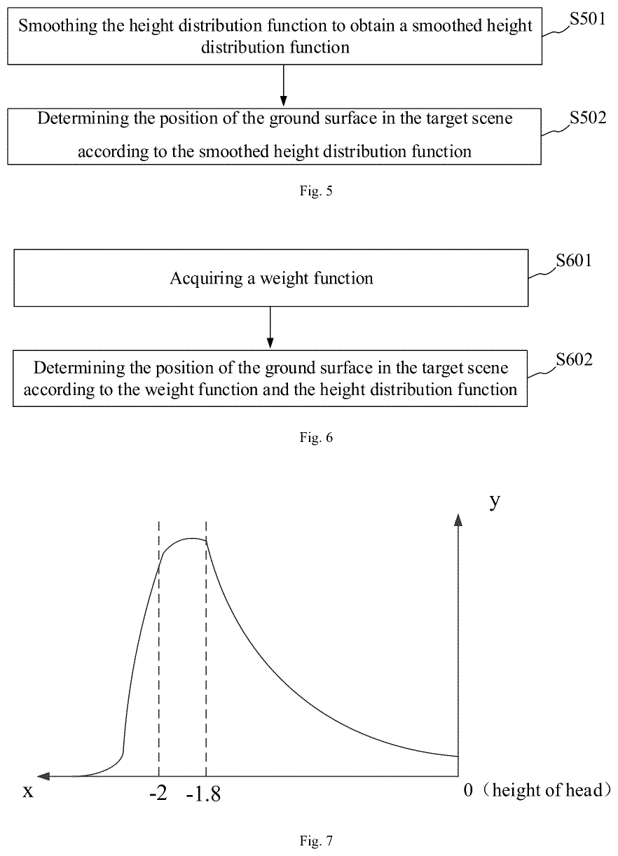

On the basis of the embodiment shown in FIG. 2, the method of determining the position of the ground surface in the target scene according to the height distribution function in the above ground surface detection method will be described in detail with reference to FIG. 5.

FIG. 5 is a schematic diagram of a method of determining the position of the ground surface provided by an embodiment of the present disclosure. Referring to FIG. 5, the method flow may include:

S501: smoothing the height distribution function to obtain a smoothed height distribution function.

For example, the smoothed height distribution function can be a distribution function obtained after smoothing the height distribution function. For example, the terminal device can smooth the height distribution function associated with the target point cloud to avoid errors caused by the sampling accuracy of the point cloud, thereby improving the accuracy of the height distribution function associated with the target point cloud and improving the accuracy of ground surface detection.

It should be noted that the terminal device can smooth the height distribution function according to any smoothing function to obtain the smoothed height distribution function, which is not limited by the embodiment of the present disclosure.

Optionally, when the height distribution function is a histogram, the terminal device can perform convolution processing on the histogram to obtain a smoothed histogram (smoothed height distribution function). For example, the histogram can be a one-dimensional sequence, and the terminal device can perform convolution processing on the one-dimensional sequence with a Gaussian convolution kernel having a radius of 6 and a standard deviation of 2 (two bins, which can correspond to 1 centimeter), and then a smoothed histogram can be obtained. In this way, the terminal device can perform convolution processing on the histogram based on Gaussian kernel, and the histogram can be smoothed with less fluctuation and higher accuracy.

It should be noted that the terminal device can smooth the histogram according to any feasible implementation to obtain the smoothed histogram, which is not limited by the embodiment of the present disclosure.

S502: determining the position of the ground surface in the target scene according to the smoothed height distribution function.

Optionally, the terminal device can determine the position of the ground surface in the target scene according to the peak corresponding to the smoothed height distribution function. For example, the terminal device can determine the position of the highest peak of the smoothed height distribution function as the position of the ground surface, and the terminal device can also determine the position of a peak whose magnitude is greater than a first threshold and less than a preset percentage of the highest peak as the position of the ground surface. For example, if the highest peak is 100, the first threshold is 50, and the preset percentage is 70%, the terminal device can determine the position of the peak whose magnitude is greater than 70 as the position of the ground surface; and if there is no peak greater than 70 in the smoothed height distribution function, the terminal device can determine the position of the highest peak as the position of the ground surface.

The embodiment of the present disclosure provides a method of determining the position of the ground surface, which smooths the height distribution function to obtain the smoothed height distribution function, so that the terminal device can determine the position of the ground surface in the target scene according to the peak corresponding to the smoothed height distribution function. In this way, according to the peak corresponding to the height distribution function, the terminal device can accurately determine the plane with lower height, more points of the target point cloud and perpendicular to the gravity direction, which improves the accuracy of ground surface detection.

On the basis of any of the above embodiments, the method of determining the position of the ground surface in the target scene according to the height distribution function in the above ground surface detection method will be described in detail with reference to FIG. 6.

FIG. 6 is another method of determining the position of the ground surface provided by the embodiment of the present disclosure. Referring to FIG. 6, the method flow includes:

S601: acquiring a weight function.

For example, the weight function is used to indicate the relationship between a weight and a height, and the weight of the weight function is inversely proportional to the height of the weight function. For example, the lower the height of the plane is, the greater the probability that the plane is the ground surface will be. Therefore, the terminal device can generate a weight function in advance, in which the greater the height is, the smaller the weight will be; and the smaller the height is, the greater the weight will be, so that the position of the ground surface can be accurately determined.

For example, the weight function can be a formula as below:

$$f ( x ) = \{ \begin{matrix}\frac{{L}_{1}}{1 + {e}^{{k}_{1} ( \vert x - {x}_{1} \vert - {x}_{2} )}} , \{ x \leq {x}_{1} \} \\ \frac{{L}_{2}}{1 + {e}^{{k}_{2} ( \vert x - {x}_{1} \vert - {x}_{3} )}} + 0.05 , \{ x > {x}_{1} \}\end{matrix} ,$$

where x is the height difference, and L₁, L₂, k₁, k₂, x₁, x₂ and x₃ can be preset parameters, where 0.05 indicates that the preset height range starts from 0.05 meter.

Hereinafter, with reference to FIG. 7, a schematic diagram of the weight function will be described.

FIG. 7 is a schematic diagram of a weight function provided by an embodiment of the present disclosure. Referring to FIG. 7, a coordinate system is included. For example, the curve corresponding to the weight function is included in the coordinate system. When x (the height difference) is less than −2, the weight decreases rapidly; when x is in the range from −2 to −1.8, the weight increases slowly; and when x is in the range from −1.8 to 0, the weight decreases slowly. Thus, the greater the height difference in the height distribution function (the lower the height) is, the larger number of points of the target point cloud will be weighted; and the smaller the height difference in the height distribution function (the greater the height) is, the smaller number of points of the target point cloud will be weighted, which improves the accuracy of ground surface detection.

It should be noted that FIG. 7 is only an example of the weight function, not a limitation of the weight function, and the terminal device can generate the weight function based on any feasible implementation, which is not limited by the embodiment of the present disclosure.

S602: determining the position of the ground surface in the target scene according to the weight function and the height distribution function.

Optionally, before the terminal device determines the position of the ground surface in the target scene according to the weight function and the height distribution function, it can also saturate the height distribution function, which can further improve the accuracy of the height distribution function associated with the target point cloud.

For example, the terminal device can saturate the height distribution function according to a saturation function. For example, the terminal device can saturate the height distribution function according to a hyperbolic tangent function. For example, if the height distribution function is a histogram, the terminal device can process the element corresponding to each bin in the histogram according to the hyperbolic tangent function to obtain the function value corresponding to each bin, backfill the function values into the bins, and then saturate the histogram. For example, in the process of practical application, the target scene can include desktops, chairs, etc. Due to the higher point cloud density of the desktop surface, there are more points of the target point cloud at the height of the desktop surface, which will interfere with the ground surface detection. The terminal device can saturate the height distribution function, thus avoiding the situation that the desktop surface, chair surface and other planes with higher point cloud density are misjudged as the ground surface, and improving the accuracy of ground surface detection.

The saturation function can be a formula as follows:

$$y = {k}_{t 1} \frac{{e}^{\frac{{k}_{t 2}}{{k}_{t 1}}} - 1}{{e}^{\frac{{k}_{t 2}}{{k}_{t 1}} x} + 1}$$

where y is the frequency after saturation, kₜ₁ and kₜ₂ are preset parameters, and x is the height difference.

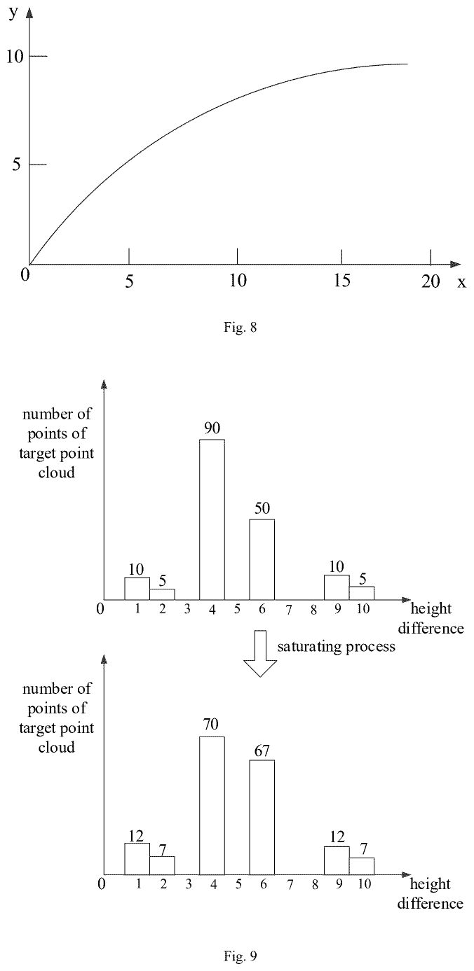

Hereinafter, the function for saturation processing will be described with reference to FIG. 8.

FIG. 8 is a schematic diagram of a saturation function provided by an embodiment of the present disclosure. Referring to FIG. 8, a coordinate system is included. For example, the coordinate system includes a hyperbolic tangent curve; when x is small, x and y are close to being in direct proportion with each other, that is, the smaller the peak of the height distribution function, the lower the degree of saturating the height distribution function by the terminal device (not shown in FIG. 8); and when x is large, y is close to a fixed value, that is, the larger the peak of the height distribution function, the higher the degree of saturating the height distribution function by the terminal device.

Hereinafter, with reference to FIG. 9, the process of saturating the height distribution function by the terminal device will be described.

FIG. 9 is a schematic diagram of a saturation processing provided by an embodiment of the present disclosure. Referring to FIG. 9, a histogram of height distribution function is included. The vertical axis of the histogram of the height distribution function is the number of the points of the target point cloud, and the horizontal axis of the histogram of the height distribution function is the height difference between the target point cloud and the image acquisition position. For example, the histogram of the height distribution function can include 10 class intervals, with the frequency of a class interval 1 being 10, the frequency of a class interval 2 being 5, the frequency of a class interval 4 being 90, the frequency of a class interval 6 being 50, the frequency of a class interval 9 being 10, the frequency of a class interval 10 being 5, and the frequency of other class intervals being 0.

Referring to FIG. 9, after the terminal device processes the histogram of the height distribution function according to the saturation function, the frequency of the class interval 1 is 12, the frequency of the class interval 2 is 7, the frequency of the class interval 4 is 70, the frequency of the class interval 6 is 67, the frequency of the class interval 9 is 12, the frequency of the class interval 10 is 7, and the frequency of other class intervals in the histogram is 0. In this way, the terminal device can reduce the difference between the frequency of the class interval 4 and the frequency of the class interval 6 through saturation processing, so as to avoid the situation that the point cloud density of other planes is higher which leads to the error of ground surface detection, thereby improving the accuracy of ground surface detection.

For example, the terminal device determines the position of the ground surface in the target scene according to the weight function and the height distribution function, which may include: weighting the height distribution function according to a weight function to obtain a weighted height distribution function, and determining a height corresponding to a first peak or a second peak in the weighted height distribution function as the height of the ground surface.

For example, after the terminal device determines the weight function, it can multiply the weight of the weight function with the value of the height distribution function, and then the weighted height distribution function can be obtained. Since the weight of the weight function is inversely proportional to the height of the weight function, the greater the height difference (the lower the height) in the height distribution function is, the more the value will be increased.

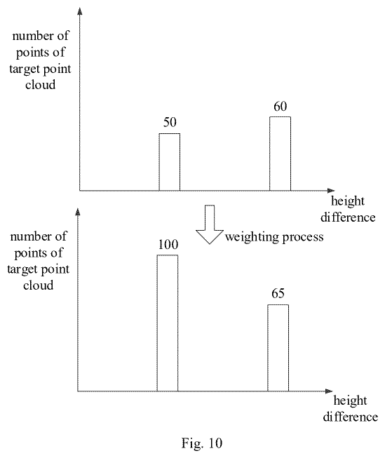

Hereinafter, with reference to FIG. 10, the process of determining the weighted height distribution function will be described.

FIG. 10 is a schematic diagram of determining a weighted height distribution function provided by an embodiment of the present disclosure. Referring to FIG. 10, a histogram of the height distribution function is included. The horizontal axis of the histogram of the height distribution function is the height difference between the target point cloud and the image acquisition position, and the vertical axis of the histogram of the height distribution function is the number of the points of the target point cloud. For example, the histogram of the height distribution function includes the class interval with frequency of 50 and the class interval with frequency of 60. After the terminal device (not shown in FIG. 10) weights the histogram of the height distribution function, the histogram of the weighted height distribution function is obtained, in which the frequency of the class interval having smaller height in the histogram is changed from 50 to 100, and the frequency of the class interval having greater height in the histogram is changed from 60 to 65. In this way, since the position of the ground surface is low, the terminal device can accurately determine the position of the ground surface based on the histogram of the weighted height distribution function, which improves the accuracy of ground surface detection.

For example, the first peak is the highest peak. For example, in the embodiment shown in FIG. 10, the histogram of the weighted height distribution function includes two peaks, and the terminal device can determine that the first peak is 100.

The second peak is a peak greater than a first threshold and less than a preset percentage of the first peak.

Optionally, the second peak is a peak greater than the first threshold and less than a preset percentage of the first peak. For example, the weighted height distribution function can include a peak A and a peak B, with the value of peak A being 100 and the value of peak B being 70. If the first threshold is 50 and the preset percentage is 0.6, the terminal device can determine that the first peak is the value of peak A. Since the value of peak B is greater than 50 and the value of peak B is greater than 60 (100*0.6), the terminal device can determine that the second peak is the value of peak B.

Optionally, the second peak may be greater than or equal to the first threshold, and the distance between the second peak and the first peak is less than or equal to a third threshold. For example, the weighted height distribution function can include a peak A and a peak B, with the value of peak A being 100, the value of peak B being 70, and the distance between peak A and peak B being 10 centimeters. If the first threshold is 50 and the third threshold is 20, the terminal device can determine that the first peak is the value of peak A. Since the value of peak B is greater than 50 and the distance between peak B and peak A is less than 20, the terminal device can determine that the second peak is the value of peak B.

Optionally, if the weighted height distribution function includes the second peak, the terminal device can determine the position corresponding to the second peak as the position of the ground surface. For example, in the process of practical application, due to the reflective characteristics of the ground surface, if there are objects such as table legs and wall edges near the ground surface, the number of the points of the target point cloud in the plane where the objects such as table legs and wall edges are located is greater than the number of the points of the target point cloud in the ground surface. Therefore, the position of the second peak in the weighted height distribution function can be the position of the ground surface.

Optionally, if the weighted height distribution function does not include the second peak, the terminal device can determine the position corresponding to the first peak as the position of the ground surface. For example, if the weighted height distribution function does not include the second peak, it means that the number of the points of the target point cloud in the plane where the ground surface is located is the largest, and there are no other planes in the target scene that interfere with the ground surface detection, so the terminal device can determine the position corresponding to the first peak as the position of the ground surface.

It should be noted that before the terminal device determines the first peak and the second peak in the weighted height distribution function, the terminal device can smooth the weighted height distribution function, thereby reducing the fluctuation of the peaks. For example, the terminal device can process the histogram of the weighted height distribution function based on a convolution kernel with a radius of 15, which decays exponentially from the center to both sides, so as to improve the accuracy of the peaks. For example, the smoothing function can be the formula as follows:

$$y = {a}^{\vert x \vert} \{ - 15 \leq x \leq 15 \} ,$$

where a is a constant, x is the frequency of the histogram of the weighted height distribution function, and y is the frequency of the smoothed histogram of the weighted height distribution function.

It should be noted that if the number of the second peak is 1, the terminal device can determine the position of the second peak as the position of the ground surface; if the number of the second peak is greater than 1, the terminal device can determine the position of the second peak with the smallest height as the position of the ground surface.

The embodiment of the present disclosure provides a method of determining the position of the ground surface, including: obtaining a weight function, weighting the height distribution function according to the weight function to obtain a weighted height distribution function, and determining the height corresponding to a first peak or a second peak in the weighted height distribution function as the height of the ground surface. In this way, the terminal device can avoid detecting other planes, that are close to the ground surface and have higher point cloud density, as the ground surface, thereby improving the accuracy of ground surface detection.

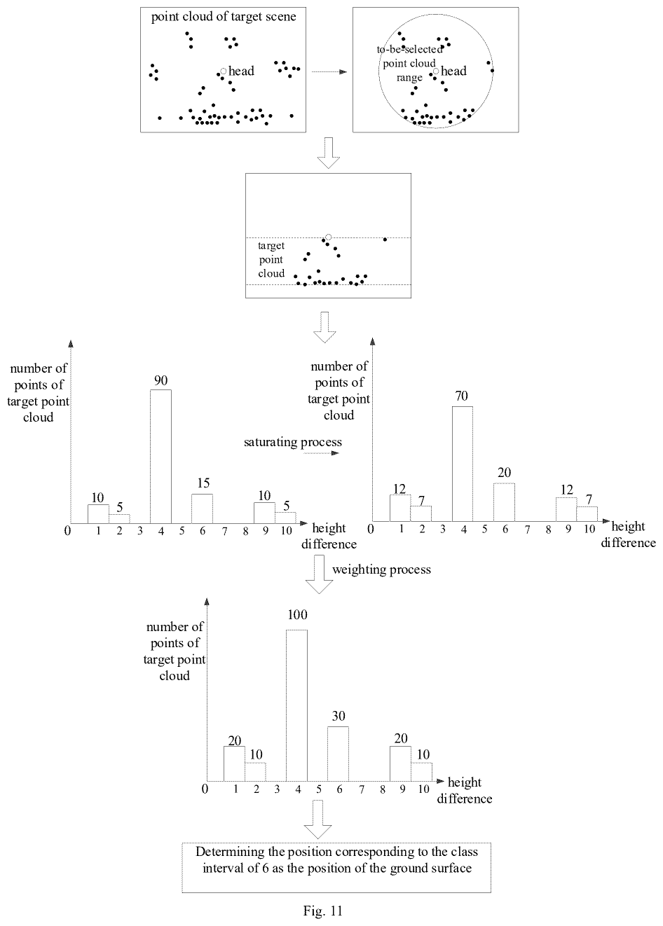

On the basis of any of the above-mentioned embodiments, the process of the above-mentioned ground surface detection method will be described below with reference to FIG. 11.

FIG. 11 is a process diagram of a ground surface detection method provided by an embodiment of the present disclosure. In the embodiment shown in FIG. 11, the image acquisition position is the position of the user's head. Referring to FIG. 11, a point cloud of the target scene is included. For example, the white circle in the target scene is the position of the user's head. A terminal device (not shown in FIG. 11) may determine a range of point cloud located within a second threshold from the user's head as a to-be-selected point cloud range. After the terminal device determines the to-be-selected point cloud range, it can further determine, from the to-be-selected point cloud range, a to-be-selected point cloud whose height is smaller than the height of the user's head and whose height difference relative to the user's head is within a preset height range, as the target point cloud.

Referring to FIG. 11, the terminal device can generate a histogram of a height distribution function according to a height distribution of the target point cloud. For example, the histogram of the height distribution function includes 10 height-correlated class intervals, the number of the points of the target point cloud in a height difference range corresponding to class interval 1 is 10, the number of the points of the target point cloud in a height difference range corresponding to class interval 2 is 5, the number of the points of the target point cloud in a height difference range corresponding to class interval 4 is 90, the number of the points of the target point cloud in a height difference range corresponding to class interval 6 is 15, the number of the points of the target point cloud in a height difference range corresponding to class interval 9 is 10, the number of the points of the target point cloud in the height difference range corresponding to class interval 10 is 5, and the frequency corresponding to other class intervals is 0.

Referring to FIG. 11, the terminal device can smooth the histogram of the height distribution function and saturate the histogram of the smoothed height distribution function to obtain the histogram of the saturated height distribution function. In the histogram of the saturated height distribution function, the number of the points of the target point cloud in the height difference range corresponding to the class interval 1 becomes 12, the number of the points of the target point cloud in the height difference range corresponding to the class interval 2 becomes 7, the number of the points of the target point cloud in the height difference range corresponding to the class interval 4 becomes 70, the number of the points of the target point cloud in the height difference range corresponding to the class interval 6 becomes 20, the number of the points of the target point cloud in the height difference range corresponding to the class interval 9 becomes 12, the number of the points of the target point cloud in the height difference range corresponding to the class interval 10 becomes 7, and the frequency corresponding to other class intervals is 0.

Referring to FIG. 11, the terminal device weights the histogram of the saturated height distribution function to obtain the histogram of the weighted height distribution function. In the histogram of the weighted height distribution function, the number of the points of the target point cloud in the height difference range corresponding to the class interval 1 becomes 20, the number of the points of the target point cloud in the height difference range corresponding to the class interval 2 becomes 10, and the number of the points of the target point cloud in the height difference range corresponding to the class interval 4 becomes 100, the number of the points of the target point cloud in the height difference range corresponding to the class interval 6 becomes 30, the number of the points of the target point cloud in the height difference range corresponding to the class interval 9 becomes 20, the number of the points of the target point cloud in the height difference range corresponding to the class interval 10 becomes 10, and the frequency of other class intervals is 0.

Referring to FIG. 11, the terminal device can determine that the value of the peak associated with the class interval 4 is the highest peak (the first peak) in the histogram of the weighted height distribution function; and since the frequency of the class interval 6 is small, there is no second peak in the histogram of the weighted height distribution function, and the terminal device can determine the position corresponding to the class interval 4 as the position of the ground surface. In this way, since a plane formed by points of the target point cloud corresponding to each class interval is perpendicular to the gravity direction of the target environment, the ground surface may be included in multiple planes, and the terminal device can avoid detecting other planes that are close to the ground surface and have high point cloud density as the ground surface, thereby improving the accuracy of ground surface detection.

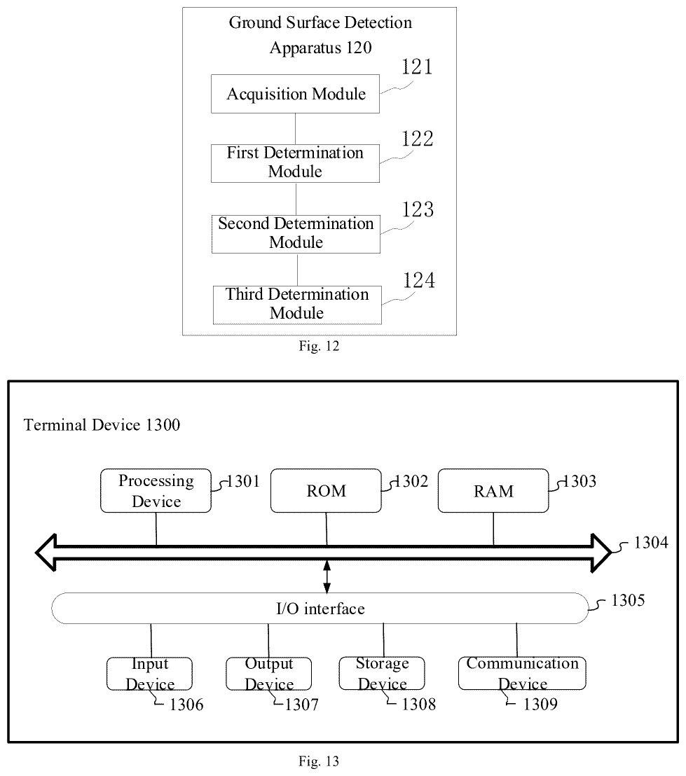

FIG. 12 is a schematic structural diagram of a ground surface detection apparatus provided by an embodiment of the present disclosure. Referring to FIG. 12, the ground surface detection apparatus 120 includes an acquisition module 121, a first determination module 122, a second determination module 123 and a third determination module 124.

The acquisition module 121 is configured to acquire an image acquisition position in a target scene.

The first determination module 122 is configured to determine a target point cloud from a point cloud related to the target scene according to the image acquisition position, where the target point cloud is located within a preset range below the image acquisition position in the target scene.

The second determination module 123 is configured to determine a height distribution of the target point cloud in the target scene.

The third determination module 124 is configured to determine a position of a ground surface in the target scene according to the image acquisition position and the height distribution of the target point cloud.

According to one or more embodiments of the present disclosure, the third determination module 124 may be configured to, for example:
generate a height distribution function according to the image acquisition position, the height distribution and a preset class interval, where an independent variable of the height distribution function is a height difference between the target point cloud and the image acquisition position, and a dependent variable of the height distribution function is a number of points of the target point cloud; and
determine the position of the ground surface in the target scene according to the height distribution function.

According to one or more embodiments of the present disclosure, the third determination module 124 may be configured to, for example:
smooth the height distribution function to obtain a smoothed height distribution function; and
determine the position of the ground surface in the target scene according to the smoothed height distribution function.

According to one or more embodiments of the present disclosure, the third determination module 124 may be configured to, for example:
acquire a weight function indicating a relationship between a weight and a height, and the weight of the weight function is inversely proportional to the height; and
determine the position of the ground surface in the target scene according to the weight function and the height distribution function.

According to one or more embodiments of the present disclosure, the third determination module 124 may be configured to, for example:
saturate the height distribution function.

According to one or more embodiments of the present disclosure, the third determination module 124 may be configured to, for example:
weight the height distribution function according to the weight function to obtain a weighted height distribution function; and
determine a height corresponding to a first peak or a second peak in the weighted height distribution function as a height of the ground surface, where the first peak is a highest peak and the second peak is a peak greater than a first threshold and less than a preset percentage of the first peak.

According to one or more embodiments of the present disclosure, the first determination module 121 may be configured to, for example:
determine a to-be-selected point cloud range from the point cloud related to the target scene according to the image acquisition position, where the to-be-selected point cloud range has a distance from the image acquisition position which is less than a second threshold; and
determine, from the to-be-selected point cloud range, a to-be-selected point cloud whose height is smaller than a height of the image acquisition position and whose height difference relative to the image acquisition position is within a preset height range, as the target point cloud.

The ground surface detection apparatus provided by the embodiment of the present disclosure can be used to implement the technical solution of the above-mentioned method embodiment, with similar implementation principle and technical effects, so the details of this embodiment are not repeated here.

FIG. 13 is a schematic structural diagram of a terminal device provided by an embodiment of the present disclosure. Referring to FIG. 13, which shows a schematic structural diagram of a terminal device 1300 suitable for implementing the embodiment of the present disclosure. For example, the terminal device may include, but is not limited to, mobile terminals such as mobile phones, notebook computers, digital broadcast receivers, Personal Digital Assistant (PDA), Portable Android Device (PAD), portable multimedia players (PMP) and vehicle-mounted terminals (such as vehicle-mounted navigation terminals); and fixed terminals such as digital TVs and desktop computers. The terminal device shown in FIG. 13 is just an example, and should not bring any limitation to the function and application scope of the embodiment of the present disclosure.

As shown in FIG. 13, the terminal device 1300 may include a processing device (such as a central processing unit, a graphics processor, etc.) 1301, which may perform various appropriate actions and processes according to a program stored in a read-only memory (ROM) 1302 or a program loaded from a storage device 1308 into a random-access memory (RAM) 1303. In the RAM 1303, various programs and data required for the operation of the terminal device 1300 are also stored. The processing device 1301, the ROM 1302 and the RAM 1303 are connected to each other through a bus 1304. An input/output (I/O) interface 1305 is also connected to the bus 1304.

Generally, the following devices can be connected to the I/O interface 1305: an input device 1306 including, for example, a touch screen, a touch pad, a keyboard, a mouse, a camera, a microphone, an accelerometer, a gyroscope, etc.; an output device 1307 including, for example, a Liquid Crystal Display (LCD), a speaker, a vibrator, etc.; a storage device 1308 such as a magnetic tape, a hard disk, etc.; and a communication device 1309. The communication device 1309 may allow the terminal device 1300 to perform wireless or wired communication with other devices to exchange data. Although FIG. 13 shows a terminal device 1300 with various devices, it should be understood that it is not required to implement or have all the devices as shown. More or fewer devices may alternatively be implemented or provided.

For example, according to an embodiment of the present disclosure, the process described above with reference to the flowchart can be implemented as a computer software program. For example, an embodiment of the present disclosure includes a computer program product, which includes a computer program carried on a computer-readable medium, and the computer program contains program code for executing the method shown in the flowchart. In such an embodiment, the computer program can be downloaded and installed from the network through the communication device 1309, or installed from the storage device 1308, or installed from the ROM 1302. When the computer program is executed by the processing device 1301, the above functions defined in the method of the embodiment of the present disclosure are performed.

It should be noted that the computer-readable medium mentioned above in the present disclosure can be a computer-readable signal medium or a computer-readable storage medium or any combination of the two. The computer-readable storage medium can be, for example, but not limited to, an electrical, magnetic, optical, electromagnetic, infrared, or semiconductor system, apparatus or device, or a combination of any of the above. Examples of the computer-readable storage medium may include, but are not limited to, an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium can be any tangible medium containing or storing a program, which can be used by or in combination with an instruction execution system, apparatus or device. In the present disclosure, a computer-readable signal medium may include a data signal propagated in baseband or as part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, apparatus or device. The program codes contained in the computer-readable medium can be transmitted by any suitable medium, including but not limited to: electrical wires, optical cables, RF (radio frequency) and the like, or any suitable combination of the above.

The computer-readable medium may be included in the terminal device; or it can exist alone without being assembled into the terminal device.

The computer-readable medium carries one or more programs, which, when executed by the terminal device, cause the terminal device to execute the method shown in the above embodiment.

An embodiment of the present disclosure provides a computer-readable storage medium in which computer-executable instructions are stored, and when the computer-executable instructions are executed by a processor, various possible methods related to the above embodiment are realized.

An embodiment of the present disclosure provides a computer program product, including a computer program, which, when executed by a processor, realizes various possible methods related to the above embodiment.

Computer program codes for performing the operations of the present disclosure may be written in one or more programming languages or their combinations, including but not limited to object-oriented programming languages, such as Java, Smalltalk, C++, and conventional procedural programming languages, such as “C” language or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The units involved in the embodiments described in the present disclosure can be realized by software or hardware. Among them, the name of the unit does not constitute any limitation of the unit itself in some cases.

The functions described above herein may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of the present disclosure, a machine-readable medium may be a tangible medium that may contain or store a program for use by or in connection with an instruction execution system, apparatus or device. The machine-readable medium may be a machine-readable signal medium or a machine-readable storage medium. A machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more lines, a portable computer disk, a hard disk, a random-access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

It should be noted that the modifications of “a” and “a plurality” mentioned in the present disclosure are schematic rather than limiting, and those skilled in the art should understand that unless the context clearly indicates otherwise, they should be understood as “one or more”.

Names of messages or information exchanged among multiple devices in the embodiment of the present disclosure are only used for illustrative purposes, and are not used to limit the scope of these messages or information.

It can be understood that prior to using the technical solutions disclosed in various embodiments of the present disclosure, users should be informed of the types, scope of use, use scenarios, etc. of personal information involved in the present disclosure in an appropriate way according to relevant laws and regulations, and authorization from users should be acquired.

For example, in response to receiving the user's active request, prompt information is sent to the user to clearly remind the user that the operation requested by the user will require for obtaining and using the user's personal information. Therefore, the user can independently choose whether to provide personal information to software or hardware such as electronic devices, application programs, servers or storage medium that perform the operation of the technical solution of the present disclosure according to the prompt information. As an optional but non-limiting implementation, in response to receiving the user's active request, the way to send the prompt information to the user can be, for example, a pop-up window, in which the prompt information can be presented in text. Moreover, the pop-up window can also carry a selection control for the user to choose “agree” or “disagree” to provide personal information to the electronic device.

It can be understood that the above process of notifying and acquiring user authorization is only schematic, and does not limit the implementation of the present disclosure. Other ways to meet relevant laws and regulations can also be applied to the implementation of the present disclosure.

It can be understood that the data involved in the technical solution (including but not limited to the data itself, data acquisition or use) shall comply with the requirements of corresponding laws, regulations and relevant regulations. Data can include information, parameters, messages, etc., such as instruction information of cutting flow.

In a first aspect, an embodiment of the present disclosure provides a ground surface detection method, including:
acquiring an image acquisition position in a target scene;
determining a target point cloud from a point cloud related to the target scene according to the image acquisition position, where the target point cloud is located within a preset range below the image acquisition position in the target scene;
determining a height distribution of the target point cloud in the target scene; and
determining a position of a ground surface in the target scene according to the image acquisition position and the height distribution of the target point cloud.

According to one or more embodiments of the present disclosure, determining a position of a ground surface in the target scene according to the image acquisition position and the height distribution of the target point cloud includes:
generating a height distribution function according to the image acquisition position, the height distribution and a preset class interval, where an independent variable of the height distribution function is a height difference between the target point cloud and the image acquisition position, and a dependent variable of the height distribution function is a number of points of the target point cloud; and
determining the position of the ground surface in the target scene according to the height distribution function.

According to one or more embodiments of the present disclosure, determining the position of the ground surface in the target scene according to the height distribution function includes:
smoothing the height distribution function to obtain a smoothed height distribution function; and
determining the position of the ground surface in the target scene according to the smoothed height distribution function.

According to one or more embodiments of the present disclosure, determining the position of the ground surface in the target scene according to the height distribution function includes:
acquiring a weight function indicating a relationship between a weight and a height, where the weight of the weight function is inversely proportional to the height; and
determining the position of the ground surface in the target scene according to the weight function and the height distribution function.

According to one or more embodiments of the present disclosure, before determining the position of the ground surface in the target scene according to the weight function and the height distribution function, the method further includes:
saturating the height distribution function.

According to one or more embodiments of the present disclosure, determining the position of the ground surface in the target scene according to the weight function and the height distribution function includes:
weighting the height distribution function according to the weight function to obtain a weighted height distribution function; and
determining a height corresponding to a first peak or a second peak in the weighted height distribution function as the height of the ground surface, where the first peak is a highest peak, and the second peak is a peak greater than a first threshold and less than a preset percentage of the first peak.

According to one or more embodiments of the present disclosure, determining a target point cloud from a point cloud related to the target scene according to the image acquisition position includes:
determining a to-be-selected point cloud range from the point cloud related to the target scene according to the image acquisition position, where the to-be-selected point cloud range has a distance from the image acquisition position which is less than a second threshold; and
determining, from the to-be-selected point cloud range, a to-be-selected point cloud whose height is smaller than a height of the image acquisition position and whose height difference relative to the image acquisition position is within a preset height range, as the target point cloud.

In a second aspect, an embodiment of the present disclosure provides a ground surface detection apparatus, including an acquisition module, a first determination module, a second determination module and a third determination module, where:
the acquisition module is configured to acquire an image acquisition position in a target scene;
the first determination module is configured to determine a target point cloud from a point cloud related to the target scene according to the image acquisition position, where the target point cloud is a point cloud located within a preset range below the image acquisition position in the target scene;
the second determination module is configured to determine a height distribution of the target point cloud in the target scene; and
the third determination module is configured to determine a position of a ground surface in the target scene according to the image acquisition position and the height distribution of the target point cloud.

According to one or more embodiments of the present disclosure, the third determination module may be configured to, for example:
generate a height distribution function according to the image acquisition position, the height distribution and a preset class interval, where an independent variable of the height distribution function is a height difference between the target point cloud and the image acquisition position, and a dependent variable of the height distribution function is a number of points of the target point cloud; and
determine the position of the ground surface in the target scene according to the height distribution function.

According to one or more embodiments of the present disclosure, the third determination module may be configured to, for example:
smooth the height distribution function to obtain a smoothed height distribution function; and
determine the position of the ground surface in the target scene according to the smoothed height distribution function.

According to one or more embodiments of the present disclosure, the third determination module may be configured to, for example:
acquire a weight function indicating a relationship between a weight and a height, and the weight of the weight function is inversely proportional to the height; and
determine the position of the ground surface in the target scene according to the weight function and the height distribution function.

According to one or more embodiments of the present disclosure, the third determination module may be configured to, for example:
saturate the height distribution function.

According to one or more embodiments of the present disclosure, the third determination module may be configured to, for example:
weight the height distribution function according to the weight function to obtain a weighted height distribution function; and
determine a height corresponding to a first peak or a second peak in the weighted height distribution function as a height of the ground surface, where the first peak is a highest peak and the second peak is a peak greater than a first threshold and less than a preset percentage of the first peak.

According to one or more embodiments of the present disclosure, the first determination module may be configured to, for example:
determine a to-be-selected point cloud range from the point cloud related to the target scene according to the image acquisition position, where the to-be-selected point cloud range has a distance from the image acquisition position which is less than a second threshold; and
determine, from the to-be-selected point cloud range, a to-be-selected point cloud whose height is smaller than a height of the image acquisition position and whose height difference relative to the image acquisition position is within a preset height range, as the target point cloud.

In a third aspect, an embodiment of the present disclosure provides a terminal device including a processor and a memory;
the memory is configured to store computer-executable instructions;
the processor is configured to execute the computer-executable instructions stored in the memory, so that the processor executes the ground surface detection method as described in the first aspect and various possible aspects of the first aspect.

In a fourth aspect, an embodiment of the present disclosure provides a computer-readable storage medium, in which computer-executable instructions are stored, and when the computer-executable instructions are executed by a processor, the ground surface detection method as described in the first aspect above and various possible aspects of the first aspect are realized.

The above description is only the preferred embodiments of the present disclosure and the explanation of the applied technical principles. It should be understood by those skilled in the art that the disclosure scope involved in the present disclosure is not limited to the technical solution formed by the specific combination of the above technical features, but also covers other technical solutions formed by any combination of the above technical features or their equivalent features without departing from the above disclosure concept. For example, the above features can be replaced with (but not limited to) technical features with similar functions disclosed in the present disclosure.

Furthermore, although the operations are depicted in a particular order, this should not be understood as requiring that these operations be performed in the particular order as shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims. With regard to the device in the above embodiment, the specific way in which each module performs operations has been described in detail in the embodiment of the method, and will not be described in detail here.

1. A ground surface detection method, comprising:
acquiring an image acquisition position in a target scene;
determining a target point cloud from a point cloud related to the target scene according to the image acquisition position, wherein the target point cloud is located within a preset range below the image acquisition position in the target scene;
determining a height distribution of the target point cloud in the target scene; and
determining a position of a ground surface in the target scene according to the image acquisition position and the height distribution of the target point cloud.

2. The method according to claim 1, wherein determining a position of a ground surface in the target scene according to the image acquisition position and the height distribution of the target point cloud comprises:
generating a height distribution function according to the image acquisition position, the height distribution and a preset class interval, wherein an independent variable of the height distribution function is a height difference between the target point cloud and the image acquisition position, and a dependent variable of the height distribution function is a number of points of the target point cloud; and
determining the position of the ground surface in the target scene according to the height distribution function.

3. The method according to claim 2, wherein determining the position of the ground surface in the target scene according to the height distribution function comprises:
smoothing the height distribution function to obtain a smoothed height distribution function; and
determining the position of the ground surface in the target scene according to the smoothed height distribution function.

4. The method according to claim 2, wherein determining the position of the ground surface in the target scene according to the height distribution function comprises:
acquiring a weight function indicating a relationship between a weight and a height, wherein the weight of the weight function is inversely proportional to the height of the weight function; and
determining the position of the ground surface in the target scene according to the weight function and the height distribution function.

5. The method according to claim 4, wherein before determining the position of the ground surface in the target scene according to the weight function and the height distribution function, the method further comprises:
saturating the height distribution function.

6. The method according to claim 4, wherein determining the position of the ground surface in the target scene according to the weight function and the height distribution function comprises:
weighting the height distribution function according to the weight function to obtain a weighted height distribution function; and
determining a height corresponding to a first peak or a second peak in the weighted height distribution function as a height of the ground surface, wherein the first peak is a highest peak, and the second peak is a peak greater than a first threshold and less than a preset percentage of the first peak.

7. The method according to claim 1, wherein determining a target point cloud from a point cloud related to the target scene according to the image acquisition position comprises:
determining a to-be-selected point cloud range from the point cloud related to the target scene according to the image acquisition position, wherein the to-be-selected point cloud range has a distance from the image acquisition position which is less than a second threshold; and
determining, from the to-be-selected point cloud range, a to-be-selected point cloud whose height is smaller than a height of the image acquisition position and whose height difference relative to the image acquisition position is within a preset height range, as the target point cloud.

8. A terminal device, comprising a processor and a memory, wherein
the memory is configured to store computer-executable instructions; and
the processor is configured to execute the computer-executable instructions stored in the memory, so as to execute a ground surface detection method, comprising:
acquiring an image acquisition position in a target scene;
determining a target point cloud from a point cloud related to the target scene according to the image acquisition position, wherein the target point cloud is located within a preset range below the image acquisition position in the target scene;
determining a height distribution of the target point cloud in the target scene; and
determining a position of a ground surface in the target scene according to the image acquisition position and the height distribution of the target point cloud.

9. The terminal device according to claim 8, wherein in the ground surface detection method,
determining a position of a ground surface in the target scene according to the image acquisition position and the height distribution of the target point cloud comprises:
generating a height distribution function according to the image acquisition position, the height distribution and a preset class interval, wherein an independent variable of the height distribution function is a height difference between the target point cloud and the image acquisition position, and a dependent variable of the height distribution function is a number of points of the target point cloud; and
determining the position of the ground surface in the target scene according to the height distribution function.

10. The terminal device according to claim 9, wherein in the ground surface detection method,
determining the position of the ground surface in the target scene according to the height distribution function comprises:
smoothing the height distribution function to obtain a smoothed height distribution function; and
determining the position of the ground surface in the target scene according to the smoothed height distribution function.

11. The terminal device according to claim 9, wherein in the ground surface detection method,
determining the position of the ground surface in the target scene according to the height distribution function comprises:
acquiring a weight function indicating a relationship between a weight and a height, wherein the weight of the weight function is inversely proportional to the height of the weight function; and
determining the position of the ground surface in the target scene according to the weight function and the height distribution function.

12. The terminal device according to claim 11, wherein in the ground surface detection method,
before determining the position of the ground surface in the target scene according to the weight function and the height distribution function, further comprising:
saturating the height distribution function.

13. The terminal device according to claim 11, wherein in the ground surface detection method,
determining the position of the ground surface in the target scene according to the weight function and the height distribution function comprises:
weighting the height distribution function according to the weight function to obtain a weighted height distribution function; and
determining a height corresponding to a first peak or a second peak in the weighted height distribution function as a height of the ground surface, wherein the first peak is a highest peak, and the second peak is a peak greater than a first threshold and less than a preset percentage of the first peak.

14. The terminal device according to claim 8, wherein in the ground surface detection method,
determining a target point cloud from a point cloud related to the target scene according to the image acquisition position comprises:
determining a to-be-selected point cloud range from the point cloud related to the target scene according to the image acquisition position, wherein the to-be-selected point cloud range has a distance from the image acquisition position which is less than a second threshold; and
determining, from the to-be-selected point cloud range, a to-be-selected point cloud whose height is smaller than a height of the image acquisition position and whose height difference relative to the image acquisition position is within a preset height range, as the target point cloud.

15. A computer-readable storage medium in which computer-executable instructions are stored, wherein
the computer-executable instructions, when executed by a processor, are configured to realize a ground surface detection method, comprising:
acquiring an image acquisition position in a target scene;
determining a target point cloud from a point cloud related to the target scene according to the image acquisition position, wherein the target point cloud is located within a preset range below the image acquisition position in the target scene;
determining a height distribution of the target point cloud in the target scene; and
determining a position of a ground surface in the target scene according to the image acquisition position and the height distribution of the target point cloud.

16. The storage medium according to claim 15, wherein in the ground surface detection method,
determining a position of a ground surface in the target scene according to the image acquisition position and the height distribution of the target point cloud comprises:
generating a height distribution function according to the image acquisition position, the height distribution and a preset class interval, wherein an independent variable of the height distribution function is a height difference between the target point cloud and the image acquisition position, and a dependent variable of the height distribution function is a number of points of the target point cloud; and
determining the position of the ground surface in the target scene according to the height distribution function.

17. The storage medium according to claim 16, wherein in the ground surface detection method,
determining the position of the ground surface in the target scene according to the height distribution function comprises:
smoothing the height distribution function to obtain a smoothed height distribution function; and
determining the position of the ground surface in the target scene according to the smoothed height distribution function.

18. The storage medium according to claim 16, wherein in the ground surface detection method,
determining the position of the ground surface in the target scene according to the height distribution function comprises:
acquiring a weight function indicating a relationship between a weight and a height, wherein the weight of the weight function is inversely proportional to the height of the weight function; and
determining the position of the ground surface in the target scene according to the weight function and the height distribution function.

19. The storage medium according to claim 18, wherein in the ground surface detection method,
before determining the position of the ground surface in the target scene according to the weight function and the height distribution function, further comprising:
saturating the height distribution function.

20. The storage medium according to claim 18, wherein in the ground surface detection method,
determining the position of the ground surface in the target scene according to the weight function and the height distribution function comprises:
weighting the height distribution function according to the weight function to obtain a weighted height distribution function; and
determining a height corresponding to a first peak or a second peak in the weighted height distribution function as a height of the ground surface, wherein the first peak is a highest peak, and the second peak is a peak greater than a first threshold and less than a preset percentage of the first peak.
